(19) United States
(12) Patent Application Publication
(10) Pub. No.: US 2006/0020556 A1
(43) Pub. Date: Jan. 26, 2006

(54) System and method for distributing electronic content utilizing electronic license keys

(76) Inventor: Jan Hakan Hamnen, Kallered (SE)

Correspondence Address: ERICSSON INC., 6300 LEGACY DRIVE, M/S EVR C11, PLANO, TX, 75024, US

(21) Appl. No.: 11/167,957

(22) Filed: Jun. 28, 2005

Related U.S. Application Data
(63) Continuation-in-part of application No. 10/883,138, filed on Jul. 1, 2004.

(51) Int. Cl. H04L 9/00

(52) U.S. Cl. 705/59; 705/65

(57) ABSTRACT

A system and method for distributing electronic content from a content creator to an end-user operating an end-user device. The end-user purchases a number of license tokens, which are electronically distributed to the end-user device from a distributor. The license tokens are utilized to access protected software in the end-user device for decrypting encrypted electronic content. The end-user selects a content piece from the distributor's menu, which indicates a content identifier and a predefined number of license tokens required for each content piece. The end-user then downloads the selected content piece in encrypted form and the device utilizes the predefined number of license tokens and the content identifier to generate a license key and access decryption software in the end-user device, which is utilized to decrypt the downloaded content piece. The consumed license tokens and decrypted content are reported to the distributor for proper allocation of revenue to those in the distribution chain.

### RELATED APPLICATIONS

This application is a continuation-in-part of U.S. patent application Ser. No. 10/883,138 entitled, Method of Distributing Electronic License Keys, filed Jul. 1, 2004 in the names of Jan Hakan Hamnen and Vidar Nicolaysen, the disclosure of which is fully incorporated herein by reference.

### BACKGROUND

The present invention relates to computer processing systems. More particularly, and not by way of limitation, the present invention is directed to a system and method for efficiently ordering and distributing electronic content, such as digitized music and video, utilizing a plurality of electronic license keys.

The rapid development of modern computer processors has resulted in hardware platforms capable of performing many different functions. Therefore in many computer appliances, the functionality available to the user depends, not on the hardware itself, but on which software has been enabled or loaded into the hardware. A common business model for such appliances uses licensing, whereby electronic license keys are used to access protected portions of the software that provide specific product functionality, features, or content that is not otherwise enabled. Such license keys enable the specific functionality, features, or content to be utilized in an identified user appliance. The appliance is identified by a “fingerprint”, for example its serial number, which is included (often encrypted) as a part of the electronic key, thereby preventing fraudulent usage.

A problem with the use of electronic license keys is that the keys have traditionally been distributed manually in a time-consuming and problematic process.

In a related field, there is currently large concern and public debate regarding improper use of electronic content (for example, digitized music and video) available on the Internet. File sharing and illegal copying and distribution has grown to a very large scale. Artists and different players in the content value chain do not have sufficient methods to protect their business interests. On one end of the chain, artists obviously want to get paid for consumption of content that they create. On the other end of the chain, the end-user wants to have access to all possible content, wherever he is, without having to pay for what he is not using. The nonexistence of an end-to-end methodology for fairly distributing electronic content causes a lack of trust between the different players. This negatively affects the entire content business, driving down the artists' willingness to produce content, and driving up lawsuits intended to counteract unlawful usage of content.

What is needed in the art is a business model that considers the end-to-end perspective and protects the business interests in the entire value chain, all the way from the artist through a distribution chain to the end-user, the content consumer. The present invention provides a system and method for generating electronic license tokens and distributing electronic content, which overcomes the disadvantages of existing methods.

### SUMMARY

In one aspect, the present invention is directed to a system for distributing electronic content from a content creator to an end-user operating an end-user device. The system includes an electronic sales mechanism for selling a license token to the end-user and electronically distributing the license token to the end-user device; a data downloading mechanism for downloading encrypted electronic content to the end-user device; and a protected software portion within the end-user device, wherein the protected software portion includes software for decrypting the encrypted electronic content. The system also includes means within the end-user device for generating a license key utilized to access the decryption software. The license key is generated based on the license token and a content identifier for the downloaded encrypted electronic content, wherein the decryption software decrypts the identified downloaded encrypted electronic content upon access by the license key.

In another aspect, the present invention is directed to a method of distributing electronic content from a content creator to an end-user operating an end-user device that includes a protected software portion. The protected software portion includes decryption software for decrypting encrypted electronic content. The method includes selling a license token to the end-user; electronically distributing the license token to the end-user device; and downloading to the end-user device, encrypted electronic content that has a content identifier. The end-user device then generates a license key for the downloaded encrypted electronic content based on the license token and the content identifier. The method also includes utilizing the license key by the end-user device to access the decryption software; and decrypting the downloaded encrypted electronic content.

In yet another aspect, the present invention is directed to a system in an end-user device for receiving from a distributor, electronic content created by a content creator. The system includes an electronic purchasing mechanism for purchasing a plurality of license tokens from the distributor; a secure memory associated with the end-user device for storing the plurality of license tokens; means for receiving from the distributor, a menu comprising a plurality of electronic content pieces; and means for selecting from the menu a desired electronic content piece having a content identifier. The system also includes a data downloading mechanism for downloading the selected electronic content piece from the distributor in encrypted form; a protected software portion that includes decryption software for decrypting the encrypted electronic content; and means for generating a license key for the selected electronic content piece based on the license token and the content identifier. The license key is utilized to access the decryption software, which decrypts the selected electronic content piece upon access by the license key.

In still yet another aspect, the present invention is directed to a method in an end-user device for receiving from a distributor, electronic content created by a content creator. The end-user device includes a protected software portion that includes decryption software for decrypting encrypted electronic content. The method includes purchasing a plurality of license tokens from the distributor; storing the plurality of license tokens in a secure memory associated with the end-user device; receiving from the distributor, a menu listing a plurality of electronic content pieces; selecting from the menu, a desired electronic content piece having a content identifier; and downloading the selected electronic content piece from the distributor in encrypted form. The end-user device then generates a license key for the selected electronic content piece based on a predefined number of license tokens and the content identifier. The method also includes accessing the decryption software utilizing the license key; and decrypting the selected electronic content piece utilizing the decryption software.

### BRIEF DESCRIPTION OF THE SEVERAL VIEWS OF THE DRAWINGS

In the following section, the invention will be described with reference to exemplary embodiments illustrated in the figures, in which:

FIG. 1 is an illustrative drawing of a method of distributing electronic license keys in accordance with the teachings of the present invention;

FIG. 2 is a simplified block diagram of the system of the present invention; and

FIG. 3 is a flow chart illustrating an end-to-end methodology for fairly distributing electronic content in accordance with the teachings of the method of the present invention.

### DETAILED DESCRIPTION

The present invention first provides a method of efficiently ordering and distributing a plurality of electronic license keys. Rather than supplying license keys for individual computer appliances, the Selling Party provides purchasers with one or more “license tokens”. License tokens represent a right to access one or more specific software features. An appliance may have several optional features (Feature-A, Feature-B, etc.), and a single-feature license token (e.g., Token-A) may provide the right to enable only Feature-A, but not Feature-B or other features. A multi-feature license token may provide the right to enable several specified features. A license token may also be a multi-user license token. Such license tokens may be delegated to additional users, in one or several steps, and may be either single-feature license tokens or multi-feature license tokens.

For a purchaser's hierarchical organization, there may be many appliances at different levels of the organization, and certain access rights may be limited to particular levels. The Selling Party may supply a multi-feature, multi-user license token to the top level of the purchaser's organization. The token specifies which features may be enabled, and how many times each feature may be enabled by the purchaser. For example, the token may provide the right to enable 50 Feature-As and 100 Feature-Bs. The purchaser can forward tokens to different levels or parts of the purchaser's organization, or can load “node-locked” license keys on particular appliances that are not authorized to pass on the license to other users. In effect, the license token is passed on between consecutive appliances or users until it has been loaded on an end-user appliance.

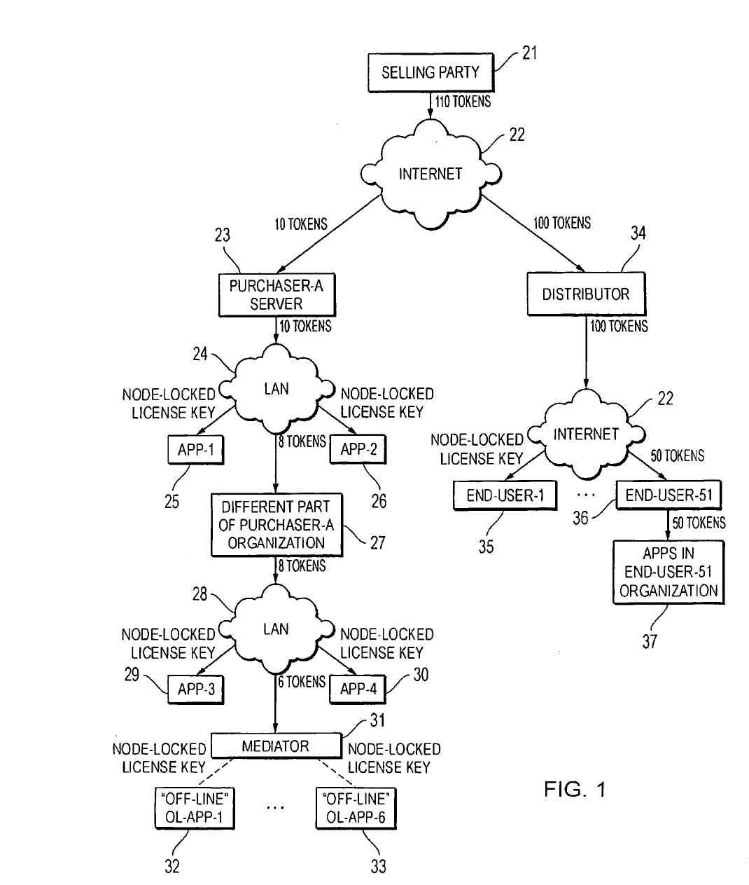

FIG. 1 is an illustrative drawing of a method of distributing electronic license tokens and generating license keys in accordance with the teachings of the present invention. In practice, a number of license tokens may be downloaded from the Selling Party 21 through, for example the Internet 22, to a central point in the purchaser's organization, such as a server 23. Of course, tokens may also be distributed by other methods such as mail, fax, telephone, and the like. In the example illustrated in FIG. 1, ten (10) single-feature tokens are downloaded to Purchaser-A's server. Alternatively, this may also be a single-feature, multi-user token authorizing ten users to enable a particular feature. For simplicity, multiple rights are referred to herein as multiple tokens. From the server, Purchaser-A distributes license tokens within Purchaser-A's organization through, for example, a Local Area Network (LAN) 24. Tokens may be distributed directly to computer appliances such as App-1 25 and App-2 26. If these appliances are end-users, and thus are not authorized to further distribute the license rights, the encrypted key string is loaded into App-1 and App-2 as node-locked license keys.

Purchaser-A may also distribute a number of license tokens to the next level in Purchaser-A's hierarchical organization or to a different part of Purchaser-A's organization 27. In the example illustrated in FIG. 1, eight (8) tokens are distributed to the different part of Purchaser-A's organization. From there, the tokens may be further distributed through LAN 28 to individual appliances App-3 29 and App-4 30 (as node-locked license keys). A number of other tokens (6 tokens in FIG. 1) are downloaded to a portable “mediator” appliance (for example a laptop computer) 31, which can be later connected to “off-line” appliances OL-App-1 32 through OL-App-6 33 to load node-locked license keys. Thus, the transfer of license rights takes place without having to manually load the license keys, and without on-line contact with the preceding “token owner”. This methodology greatly simplifies the distribution of license rights in an organization.

A number of license tokens may also be downloaded from the Selling Party 21 to a Distributor 34 who then distributes the license tokens through, for example the Internet 22, to end-users 35 and 36. The Distributor may also sell appliances to end-users, and in this case, the Distributor may load a node-locked license key on the appliance prior to delivering the appliance, rather than distributing a token. The original number of tokens provided by the Selling Party (100 tokens in FIG. 1) can be subdivided into smaller numbers, thereby enabling further distribution of the rights. For example, end-user-1 35 may have a single appliance, and therefore, a single node-locked license key is downloaded to end-user-1. Alternatively, end-user-51 36 may have a large number of appliances needing licenses (50 appliances in FIG. 1), and therefore, 50 license tokens are downloaded to end-user-51. In turn, end-user-51 then distributes license tokens and/or node-locked license keys to appliances 37 within end-user-51's organization.

The present invention also provides a method of efficiently ordering and distributing electronic content using a plurality of electronic license keys. Electronic license keys have traditionally been distributed in a time-consuming and problematic process. Co-owned and co-pending U.S. patent application Ser. No. 10/883,138, fully incorporated by reference herein, discloses a method that overcomes the disadvantages of existing methods by efficiently ordering and distributing a plurality of electronic license tokens, which are then utilized to generate license keys. The present invention builds upon this efficient method of generating electronic license keys to facilitate ordering and distribution of electronic content such as digitized music and video.

In the context of electronic content, the present invention utilizes the distributed license tokens as a currency to pay for content decryption and usage. The tokens are prepaid towards a content distributor, and may be used online or offline by the end-user to decrypt and consume content provided by the distributor. In the preferred embodiment, the end-user may download encrypted content without cost to the end-user. However, the end-user must “spend” license tokens to enable decryption software on the end-user's appliance to decrypt the downloaded content. The distributor may provide price-differentiated offers that enable end-users to download different pieces of encrypted content over the Internet. Different number of tokens may be required to enable decryption of different pieces of content. Furthermore, the invention may include a reporting function that collects and reports the usage of tokens (including information on the pieces of content consumed) for each distributor. The reporting function thus enables the content creator/artist to get paid according to the level of usage.

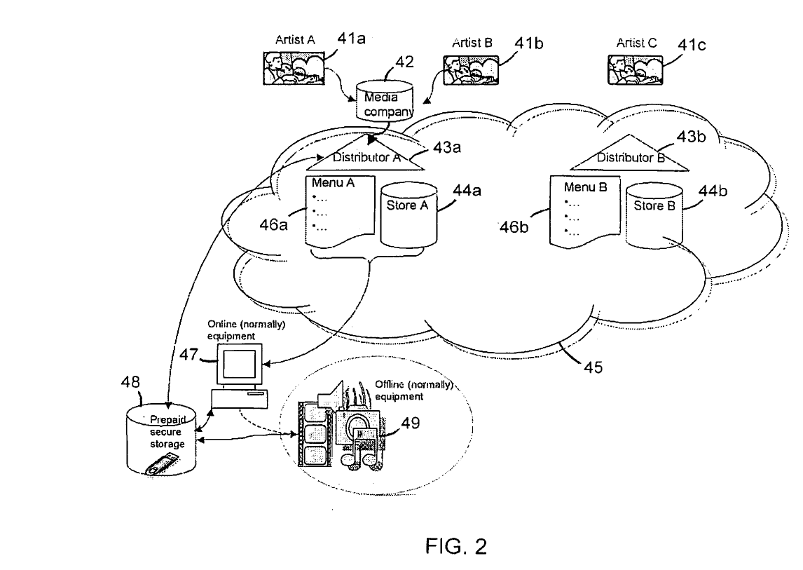

FIG. 2 is a simplified block diagram of an exemplary embodiment of the system of the present invention. A number of content creators/artists such as Artist-A 41a and Artist-B 41b are each connected to a media company 42 such as a movie or television studio for producing video content, or a music studio for producing audio content. The media company may distribute the content itself, or may utilize one or more distributors such as Distributor-A 43a to provide the content to the end-user. The distributors may distribute the content from several media companies, and consequently, the total content provided by the distributors can be very large. Other creators/artists such as Artist-C 41c may distribute their content directly through a distributor such as Distributor-B 43b.

In one embodiment of the present invention, Distributor-A 43a stores its content database in a Store-A 44a, and makes the content database available over the Internet 45 in an encrypted form. Additionally, Distributor-A provides an associated listing of the content database (Menu-A) 46a, including a differentiated price list for the content offerings. Thus, Menu-A specifies the price, which may be different for different pieces of content (for example, high for the latest super-hit song). The price may also be different for different forms of usage (for example, a lower price for single play usage and a higher price for eternal usage). Distributor-A may regularly update the content database and Menu-A to reflect new pieces of content and/or new prices. Likewise, Distributor-B 43b stores its content database in a Store-B 44b, and makes the content database available over the Internet 45 in an encrypted form. Additionally, Distributor-B provides an associated listing of the content database (Menu-B) 46b.

Utilizing the process shown in FIG. 1, the distributors supply distributor-specific license tokens to the end-users to enable the end-users to generate license keys and decrypt downloaded content. Rather than having a dedicated key for each piece of content (which would require a very large number of different keys), each content piece and type of usage requires a predefined number of (identical) tokens to be decrypted. Thus, the license token is utilized as a unit of “currency”, and the menu is the price list, expressed in this currency. From time-to-time, and depending on the distributor, the exchange rate between tokens and ordinary currencies may be changed.

The end-user can purchase pre-paid tokens for a specific distributor for later use to decrypt and consume content. The end-user may acquire the tokens in various ways such as, for example, an on-line Internet session in which tokens are provided to the end-user in exchange for a financial transaction based on a credit card. Alternatively, the transaction may purchase the tokens over-the-counter at a distributor's store or from third-party vendors of prepaid tokens, in the same fashion as pre-paid services for mobile telephony can be purchased in a local store. In this case, the end-user may be given a code that will later be a credit for downloading a number of tokens in an on-line session with the distributor.

Referring still to FIG. 2, the end-user may obtain the tokens using online equipment 47, and may store the tokens on a secure storage device 48 such as, for example, an encrypted USB flash memory, smart card, hard drive, or SIM-card. For simplicity, the description herein refers to the secure storage device as a secure “USB device”. Such a USB device contains a “fingerprint”, i.e., a unique identifier whereby the user can be distinguished, as seen from the distributor. The USB device may also contain a log of the token usage. Using the procedure shown in FIG. 1, the tokens may also be distributed to offline equipment 49.

By utilizing portable equipment such as an MP3-player, the end-user can download the encrypted content database into his portable equipment. If the portable equipment is equipped with an interface for the USB device, it can be connected to the USB device in order to spend the stored tokens to decrypt and consume content. The end-user can also share the encrypted content database and its associated menu with other end-users. Those end-users may be allowed to use the first end-user's tokens or otherwise must spend their own tokens to decrypt and consume the shared content.

As noted above, the end-user's equipment 47 and 49 includes a software application for decrypting chosen pieces of the downloaded database, paired with the consumption of tokens in accordance with the menu. The software application is also adapted to communicate with the USB device, and to determine from the menu, the number of tokens to be consumed in connection with a particular choice of content and/or type of usage. The consumption of tokens may be stored, in secure format, on the USB device, together with information regarding which pieces of content were decrypted and consumed. Whenever one of the end-users' equipment is connected to the distributor's portal, the usage log stored on the USB device may be uploaded through the Internet to the distributor. The distributor may use the information thus compiled to compensate the media companies/artists in accordance with relevant agreements.

Thus, the present invention provides a complete business chain for content on the Internet. The invention enables the end-user to consume content where and when he wants, online or offline, provided he has purchased tokens from the distributor of his choice in advance. The invention provides the end-user with access to any content he would potentially desire, but requires that the end-user only pay for what he uses. Additionally, the media company and the artists are paid for what was actually consumed.

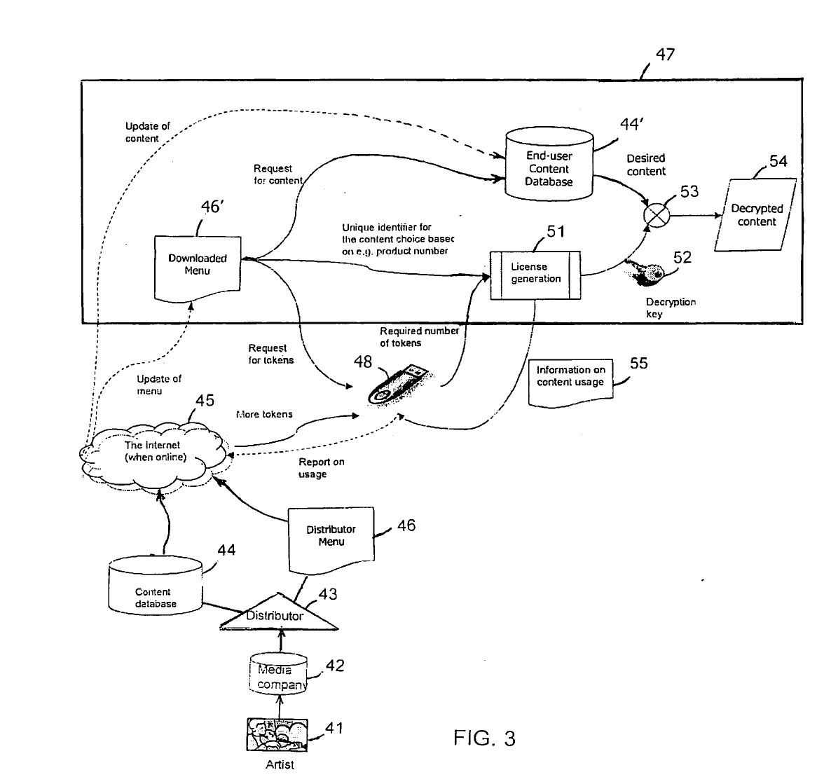

FIG. 3 is a flow chart illustrating an end-to-end methodology for fairly distributing electronic content in accordance with the teachings of the method of the present invention. Utilizing the process shown in FIG. 1, an end-user acquires prepaid license tokens from a distributor 43 over the Internet 45 and stores the tokens in a secure internal database or USB device 48. License tokens may contain information regarding the selling distributor, so that the end-user may simultaneously carry tokens originating from different distributors, thereby enabling consumption of content from different databases 44. The tokens may utilize various techniques to improve tamper-resistance. The end-user then accesses the menu 46 and requests content from the content database 44. If the distributor utilizes price differentiation for different pieces of content, the menu may contain tamper-resistant information on the number of license tokens required to decrypt the requested content. The end-user then downloads the requested content in encrypted form into an end-user content database 44′ (and the corresponding menu 46′). Note that the end-user may download a few selected pieces of content, a substantial portion of the distributor's content database 44, or all of the distributor's content database free of charge since the content is encrypted, and can only be decrypted by “spending” purchased license tokens. The menu and downloaded content may also include free samples of some or all of the content pieces so that the end-user can get a snapshot of a piece before deciding to decrypt it.

The end-user then selects a desired piece of content from the downloaded menu 46′. If the end-user has enough tokens stored in its internal database or USB device 48, the number of tokens associated with the desired content piece are cashed in, and a license key 52 is generated enabling the decryption software 53 on the end-user's appliance to decrypt the downloaded content into consumable content 54. The license key is a string of characters generated by the end-user device at step 51. The string is generated based on a unique identifier for the selected content piece retrieved from the menu 46′, paired with consumption of the specified number of tokens. Generally, the license key is able to open only the selected content piece. Note, however, that the key does not have to be fully unique as long as it is rare that a license key will open a different piece of content.

Generation of the licenses 52 causes information on the content usage 55 to be generated. The usage information is reported through the Internet 45 to the distributor 43. A clearinghouse-type operation then allocates revenue from the usage to appropriate media companies 42 and creators/artists 41.

An end-user may typically download without charge, a large portion of the distributor's encrypted content database 44, together with the menu 46, and store the encrypted content in the end-user content database 44′ and downloaded menu 46′ associated with the end-user appliance. This content may be forwarded to other devices such as an MP3 player, or may be forwarded to other end-users without charge. The end-user can then peruse the menu 46′ off-line, and select, decrypt, and consume various content pieces, as desired. Whenever a content piece is decrypted, the identification of the content piece is recorded, and the associated number of tokens are recorded as being consumed. The next time the end-user goes on-line with the distributor (for example, to purchase additional tokens), the consumed content and tokens are reported to the distributor. The distributor may require the end-user to log on periodically so that consumed tokens can be reported in a timely manner.

Thus, the present invention provides an end-to-end methodology for fairly distributing electronic content, whereby end users have virtually unlimited access to content, paying only for what they use, with a secured revenue stream all the way to the content creator/artist. The end-user can download all content of interest on any of his devices without any cost for the download itself. The invention also enables super distribution by enabling end-users to distribute content to other end-users, thereby making the distribution process more efficient. Additionally, the invention enables price differentiation, whereby pricing for different pieces of content can be set differently, depending on demand and on the usage conditions.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A system for distributing electronic content from a content creator to an end-user operating an end-user device, said system comprising:
a sales mechanism for selling a license token to the end-user and distributing the license token to the end-user device;
a data downloading mechanism for downloading encrypted electronic content to the end-user device;
a protected software portion within the end-user device, wherein the protected software portion includes decryption software for decrypting the encrypted electronic content; and
means within the end-user device for generating a license key utilized to access the decryption software, wherein the license key is generated based on the license token and a content identifier for the downloaded encrypted electronic content, wherein the decryption software decrypts the identified downloaded encrypted electronic content upon access by the license key.

2. The system of claim 1, wherein the electronic sales mechanism sells a plurality of license tokens to the end-user, and the system further comprises a secure memory associated with the end-user device for storing the plurality of license tokens.

3. The system of claim 2, further comprising means for generating information indicating that a license token has been consumed whenever a license token is utilized to generate the license key.

4. The system of claim 3, further comprising a reporting mechanism for reporting to the distributor that the license token has been consumed by the end-user.

5. The system of claim 2, wherein the data downloading mechanism downloads a plurality of encrypted electronic content pieces to the end-user device together with a menu that enables the end-user to select desired content pieces for decryption.

6. The system of claim 5, wherein the menu indicates a number of license tokens required to decrypt each content piece on the menu.

7. The system of claim 6, wherein the menu includes a content identifier for each content piece, and the means for generating the license key utilizes the content identifier for a selected content piece together with the required number of license tokens for the selected content piece to generate a license key that enables decryption of only the selected content piece.

8. The system of claim 5, further comprising a data forwarding mechanism in the end-user device for forwarding downloaded encrypted electronic content to other end-user devices.

9. A method of distributing electronic content from a content creator to an end-user operating an end-user device that includes a protected software portion, wherein the protected software portion includes decryption software for decrypting encrypted electronic content, said method comprising:
selling a license token to the end-user;
distributing the license token to the end-user device;
downloading encrypted electronic content to the end-user device, said content having a content identifier;
generating a license key for the downloaded encrypted electronic content based on the license token and the content identifier;
utilizing the license key by the end-user device to access the decryption software; and
decrypting the downloaded encrypted electronic content.

10. The method of claim 9, wherein the steps of selling a license token, distributing the license token, and downloading the encrypted electronic content are performed by a media company.

11. The method of claim 9, wherein the steps of selling a license token, distributing the license token, and downloading the encrypted electronic content are performed by a distributor of the electronic content.

12. The method of claim 11, further comprising, after the step of distributing the license token to the end-user device, the step of storing the license token in a secure memory associated with the end-user device.

13. The method of claim 12, further comprising, after the step of generating a license key for the downloaded encrypted electronic content based on the license token and the content identifier, the step of generating information indicating that the license token has been consumed to generate the license key for the downloaded content.

14. The method of claim 13, further comprising reporting to the distributor that the license token has been consumed by the end-user, and the content identifier of the decrypted content.

15. The method of claim 9, further comprising forwarding downloaded encrypted electronic content from the end-user device to other end-user devices.

16. A system in an end-user device for receiving from a distributor, electronic content created by a content creator, said system comprising:
a purchasing mechanism for purchasing a plurality of license tokens from the distributor;
a secure memory associated with the end-user device for storing the plurality of license tokens;
means for receiving from the distributor, a menu comprising a plurality of electronic content pieces;
means for selecting from the menu a desired electronic content piece having a content identifier;
a data downloading mechanism for downloading the selected electronic content piece from the distributor in encrypted form;
a protected software portion that includes decryption software for decrypting the encrypted electronic content; and
means for generating a license key for the selected electronic content piece based on the license token and the content identifier, wherein the license key is utilized to access the decryption software, which decrypts the selected electronic content piece upon access by the license key.

17. The system of claim 16, wherein the menu indicates a predefined number of license tokens associated with, and required to be consumed, to generate a license key for each electronic content piece.

18. The system of claim 17, further comprising means for generating information indicating that a license token has been consumed whenever a license token is utilized to generate the license key.

19. The system of claim 18, further comprising a reporting mechanism for reporting to the distributor, the number of license tokens that have been consumed by the end-user, and the content identifiers of the decrypted content pieces.

20. The system of claim 16, further comprising a data forwarding mechanism for forwarding downloaded encrypted electronic content to other end-user devices.

21. A method in an end-user device for receiving from a distributor, electronic content created by a content creator, wherein the end-user device includes a protected software portion that includes decryption software for decrypting encrypted electronic content, said method comprising:
purchasing a plurality of license tokens from the distributor;
storing the plurality of license tokens in a secure memory associated with the end-user device;
receiving from the distributor, a menu listing a plurality of electronic content pieces;
selecting from the menu, a desired electronic content piece having a content identifier;
downloading the selected electronic content piece from the distributor in encrypted form;
generating a license key for the selected electronic content piece based on a predefined number of license tokens and the content identifier;
accessing the decryption software utilizing the license key; and
decrypting the selected electronic content piece utilizing the decryption software.

22. The method of claim 21, wherein the menu indicates a predefined number of license tokens associated with, and required to be consumed, to generate a license key for each electronic content piece.

23. The method of claim 22, further comprising:
recording the content identifier of the decrypted electronic content piece; and
recording that the predefined number of license tokens were consumed.

24. The method of claim 23, further comprising reporting to the distributor, the content identifier of the decrypted electronic content piece and the number of tokens consumed.

25. The method of claim 24, wherein after downloading the selected electronic content piece, the generating, accessing, decrypting, and recording steps are performed off-line, and the reporting step is performed when the end-user device next logs onto the distributor's website.

26. The method of claim 21, wherein the step of purchasing a plurality of license tokens includes purchasing the plurality of tokens over-the-counter at a distributor's store or a third-party vendor's store.

27. The method of claim 26, wherein the step of purchasing the plurality of tokens over-the-counter at a distributor's or third-party vendor's store includes:
obtaining a distributor's code; and
downloading the tokens over the Internet to the secure memory associated with the end-user device utilizing the distributor's code.

28. The method of claim 21, wherein the step of purchasing a plurality of license tokens includes:
purchasing the plurality of tokens at the distributor's website; and
downloading the tokens to the end-user device over the Internet.

29. The method of claim 21, wherein the step of storing the plurality of license tokens in a secure memory includes storing the tokens in a memory device selected from the group consisting of a plug-in USB flash memory, a smart card, and a hard drive utilized with the end-user device.

30. The method of claim 21, wherein the step of downloading the selected electronic content piece in encrypted form is performed at no cost to the end-user.

31. The method of claim 21, wherein the step of selecting a desired electronic content piece includes selecting a plurality of desired electronic content pieces, which are downloaded in encrypted form and stored in a content database associated with the end-user device.

32. The method of claim 21, further comprising forwarding downloaded encrypted electronic content from the end-user device to other end-user devices.

33. The method of claim 32, wherein the step of forwarding downloaded encrypted electronic content includes forwarding the downloaded encrypted electronic content from the end-user device to a portable music player.

34. The method of claim 32, wherein the step of forwarding downloaded encrypted electronic content includes forwarding the downloaded encrypted electronic content from the end-user device to end-user devices belonging to other end-users.
